(19) United States
(12) Patent Application Publication
(10) Pub. No.: US 2004/0161496 A1
(43) Pub. Date: Aug. 19, 2004

(54) Process for the fortification of a fruit-based food product with calcium

(76) Inventors: Simone Johanna Bouman, Almkerk (NL); Elize Willem Bontenbal, Wageningen (NL)

Correspondence Address: PATENT ADMINSTRATOR, KATTEN MUCHIN ZAVIS ROSENMAN, 525 WEST MONROE STREET, SUITE 1600, CHICAGO, IL, 60661-3693, US

(21) Appl. No.: 10/247,308

(22) Filed: Sep. 20, 2002

Related U.S. Application Data
(63) Continuation-in-part of application No. 09/956,856, filed on Sep. 21, 2001, now abandoned.

(30) Foreign Application Priority Data
Sep. 21, 2001 (EP) 01203615.8

(51) Int. Cl. A23K 1/175

(52) U.S. Cl. 426/74

(57) ABSTRACT

The present invention relates to a process for the fortification of food products containing fruit, such as fruit juices, concentrates, syrups or spreads with calcium. According to this process an inorganic calcium salt and a calcium salt of all organic acid are added to the fruit containing food product. In particular this method is suitable for food products with fruit containing anthocyanins, such as cranberries. A preferred combination of calcium salts is a calcium salt of lactic acid with calcium chloride.

### CROSS REFERENCE TO RELATED APPLICATIONS

This application is a continuation-in-part of U.S. patent application Ser. No. 09/956,856, filed Sep. 21, 2001.

### CLAIM TO PRIORITY

This application claims priority of U.S. patent application Ser. No. 09/956,856, filed Sep. 21, 2001, and European Patent Application 01 203 615.8, filed Sep. 21, 2001, the disclosures of which are hereby incorporated in their entirety by reference.

### BACKGROUND OF THE INVENTION

The present invention relates to a process for the fortification of food products containing fruit, such as fruit juices, concentrates, syrups or spreads, with calcium.

Such processes are known from the prior art. In WO 00/28838, a calcium fortified juice-based nutritional beverage is described containing depectinized fruit juice and a source of calcium selected from natural milk mineral, calcium lactate gluconate, or mixtures thereof. The beverage can further contain nutrients such as vitamins. In EP 397 232, a nutritional beverage containing fruit juice is described wherein, as a calcium source, calcium chloride, calcium carbonate or calcium-citrate-malate is used.

U.S. Pat. No. 6,086,927 describes a process for preparing a calcium enriched food product by subsequently mixing, in water or fruit juice, calcium hydroxide, a phosphorus based acid, calcium lactate and calcium phosphate. The mixture comprises about 40 wt. % of total calcium derived from calcium hydroxide, about 15 wt. % of total calcium derived from calcium lactate, and about 45 wt. % of total calcium derived from calcium phosphate.

The problem that can arise when calcium compounds are added to fruit-based food products is that color changes can occur, particularly in the case of juices or concentrates obtained from fruit containing pH-sensitive color pigments such as, for instance, anthocyanins. Anthocyanins are stable at low pH. At higher pH a discoloration from red or blue to brown occurs. This is undesirable. Besides color stability it is required that the fortified products have a stable and acceptable flavor.

### SUMMARY OF THE INVENTION

The object of the invention is to provide a process for the fortification of food products containing fruit with calcium such that the color and preferably also the flavor of the food product is acceptable and remains stable over a longer period of time.

The invention thus provides a process for fortifying food products containing fruit with calcium, comprising adding to the food product an inorganic calcium salt and a calcium salt of an organic acid. Preferably, at least 20 wt. % of total calcium added is supplied by the organic calcium salt, more preferably at least 50 wt. % of total calcium added is supplied by the organic calcium salt. It was found that when at least 20 wt. % of the total calcium is supplied by organic calcium salt a good taste of the food product may be ensured.

### DETAILED DESCRIPTION OF THE INVENTION

The calcium salt of an organic acid is preferably selected from calcium salts of suitable food grade carboxylic acids, in particular lactic acid, gluconic acid, citric acid, malic acid, fumaric acid, tartaric acid, adipic acid or mixtures thereof, most preferably lactic acid. Examples of these calcium salts are calcium lactate, calcium gluconate, calcium citrate (mono calcium citrate, di calcium citrate, tri calcium citrate, sodium calcium citrate, potassium calcium citrate, ammonium calcium citrate), calcium citrate/malate, calcium malate, calcium amino acid chelates and calcium fumarate.

The calcium salt of organic acid can also be obtained by in situ formation by addition of the organic acid, or a potassium, sodium and/or ammonium salt thereof, and calcium hydroxide, calcium hydrate and/or calcium carbonate to the food product.

The inorganic calcium salt is preferably selected from calcium chloride, calcium phosphate (mono calcium phophate, di calcium phosphate, tri calcium phosphate, sodium calcium phosphate, potassium calcium phosphate, ammonium calcium phosphate), calcium sulfate, calcium hydroxide, calcium hydrate, calcium carbonate and mixtures thereof, preferably calcium chloride, calcium phosphate or calcium sulfate, most preferably calcium chloride. It should be noted that if the calcium salt of organic acid is formed in situ, the inorganic calcium salt is selected from calcium chloride, calcium phosphate or calcium sulfate.

When the inorganic calcium salt is calcium chloride or calcium phosphate, it can also be obtained by in situ formation, by addition of calcium hydroxide, calcium hydrate and/or calcium carbonate in combination with phosphoric acid or a potassium, sodium and/or ammonium salt thereof and/or hydrochloric acid.

Preferably, at least 20 wt. % of total calcium added is supplied by the inorganic calcium salt. It was found that when at least 20 wt. % of the total calcium is supplied by inorganic calcium salt a good colour stability of the food product may be ensured.

Thus, most preferably 20-80 wt. % of total calcium is supplied by the inorganic acid salt and 20-80 wt. % of total calcium is supplied by the organic calcium salt, preferably calcium lactate.

As a source for inorganic calcium salts also nature derived calcium sources can be used such as milk calcium, sea weed calcium or calcium obtained from shells. These products contain for example calcium carbonate or calcium phosphate.

According to a further aspect the invention relates to a process as described above wherein the inorganic calcium salt is a calcium phosphate selected from mono calcium phosphate, di calcium phosphate, tri calcium phosphate, sodium calcium phosphate, potassium calcium phosphate, ammonium calcium phosphate and the amount of calcium supplied by the calcium phosphate is 15 to 100%. These salts can also be formed in situ, as described above.

The invention also relates to the calcium-enriched food product obtained with the process described above, which contains an added inorganic calcium salt and an added calcium salt of an organic acid, wherein preferably at least 20 wt. % of the total added calcium is supplied by the organic calcium salt. Preferably the product contains 50 to 80 wt. % of the total added calcium from calcium lactate and 20 to 50 wt. % of the total added calcium from calcium chloride. With added calcium is meant the calcium which is not naturally present in one of the raw materials of the food product. This means, for instance, that when the food product contains milk, the milk calcium already present in the milk is not included in the balance of total added calcium.

The food product containing fruit of the invention includes not only juices, but also fruit concentrates, fruit based beverages, nectars, syrups etc. containing fruit. Food products can also be spreads, which includes spreadable fruit products such as jams, marmalades and fruit filings.

The process of the invention is particularly suitable for food products based on fruit containing anthocyanins, such as blueberries, bilberries, cranberries, elderberries, strawberries, raspberries, blackberries, blackcurrants, red, black and blue grapes, plums and cherries.

The product obtained after fortification with calcium has a pH lower than 4.5, preferably lower than 3.5, in particular between 2.5 and 3.5.

The calcium concentration in the final product after fortification is determined by the recommended values for daily food intake, but is in particular less than 3000 ppm, preferably less than 600 ppm. A suitable calcium concentration in the juice or spread is 400 to 900 ppm.

### EXAMPLES

### Example 1

Orange juice and apple juice were fortified with 1200 ppm calcium. Calcium phosphate and calcium lactate were added in various ratios. After 5 days at 40° C. the color, pH and taste were analysed. The results are compiled in TABLES 1 and 2.

TABLE 1
Orange juice fortified with calcium lactate/calcium phosphate

| Ratio % Calcium | | | |
|---|---|---|---|
| from lactate/ | | | |
| phosphate | pH | Color stability | Taste |
| blank | 3.73 | Good | Good |
| 100:0 | 3.84 | Good | Good |
| 75:25 | 3.78 | Good | Good |
| 50:50 | 3.71 | Good | Good |
| 25:75 | 3.63 | Good | Good |
| 0:100 | 3.53 | Good | Bitter |

TABLE 2
Apple juice fortified with calcium lactate/calcium phosphate

| Ratio % Calcium | | | |
|---|---|---|---|
| from lactate/ | | | |
| phosphate | pH | Color stability | Taste |
| blank | 3.50 | Good | Good |
| 100:0 | 3.86 | Good | Good |
| 75:25 | 3.78 | Good | Good |
| 50:50* | 3.69 | Good | Good |
| 25:75* | 3.58 | Good | Good |
| 0:100* | 3.44 | Good | Bitter |

*a precipitation was present

TABLES 1 and 2 show that when more than 75 wt. % of the calcium originates from calcium phosphate, the taste is detrimentally affected. Thus, when at least 20 wt. % of the calcium added originates from calcium lactate, a good taste is ensured. The same tests were performed with calcium lactate/calcium citrate blends, and the same results were obtained.

### Example 2

Cranberry juice was fortified with 500 ppm calcium. First calcium lactate was added to the juice and stirred until all was dissolved. Thereafter calcium chloride was added. The pH was measured and the flavor was assessed. The juices were then stored at 35° C. for 40 hours to check color stability.

In TABLE 3, results of this experiment are shown:

TABLE 3

| Calcium | Calcium | | | |
|---|---|---|---|---|
| of calcium | of calcium | | Color | |
| lactate (ppm) | chloride (ppm) | pH | stability | Taste |
| 0 | 0 | 2.67 | | |
| 0 | 500 | 2.53 | Very light, | Chlorine/bitter |
| | | | watery | |
| 100 | 400 | 2.62 | Good | Chlorine/bitter |
| 200 | 300 | 2.71 | Good | Chlorine/bitter |
| 300 | 200 | 2.80 | Good | Good |
| 400 | 100 | 2.91 | Good | Good |
| 500 | 0 | 3.00 | Light/ | Tart/astringent |
| | | | brownish | |

These results show that good color stability is ensured when at least 20 wt. % of the calcium supplied originates from the inorganic acid calcium salt, whereas a good taste is ensured when at least 20 wt. % of the calcium originates from the organic acid calcium salt.

### Example 3

Lemonade syrup (Orange form ex Karvan-Cevitam) was fortified with a blend of calcium lactate/calcium chloride (dosing level 20% RDI per serving of 250 ml). The results on pH and taste are compiled in TABLE 4.

TABLE 4
Lemonade syrup juice fortified with calcium lactate/calcium
chloride

| Ratio % Calcium | | |
|---|---|---|
| from lactate/ | | |
| chloride | pH | taste |
| blank | 3.21 | Good |
| 100:0 | 2.96 | Good |
| 75:25 | 3.39 | Good |
| 50:50 | 3.62 | Good |
| 25:75 | 3.79 | Little chloride |
| | | off flavor |
| 0:100 | 3.91 | Chlorine off |
| | | flavor→ not |
| | | acceptable |

These results show that, in lemonade syrups also, a combination of calcium lactate and an inorganic calcium salt is necessary to obtain acceptable flavor. A good taste is ensured with at least 20 wt. % of the calcium supplied by the organic acid calcium salt.

### Example 4

Drink yoghurt was fortified (675 ppm) with a blend of calcium lactate and mono calcium citrate. When at least 20 wt. % of the calcium supplied originated from calcium lactate a good taste was ensured.

What is claimed is:

1. A process for fortifying a food product containing fruit with calcium, comprising adding to the food product an inorganic calcium salt and a calcium salt of an organic acid.

2. The process according to claim 1 wherein at least 20 wt. % of total calcium added is supplied by the organic calcium salt.

3. The process according to claim 2 wherein the organic calcium salt is calcium lactate.

4. The process according to claim 1, wherein at least 20 wt. % of the total calcium added is supplied by the inorganic calcium salt.

5. The process according to claim 1 wherein 20 to 80 wt. % of the total calcium added is supplied by the organic calcium salt and 20 to 80 wt. % is supplied by the inorganic calcium salt.

6. The process according to claim 1, wherein the fruit in the food product is a fruit containing pH-sensitive color pigments.

7. The process according to claim 6, wherein the fruit in the food product is a fruit containing anthocyanins.

8. The process according to claim 7, wherein the fruit is selected from blueberries, bilberries, cranberries, elderberries, strawberries, raspberries, blackberries, blackcurrants, red, black and blue grapes, plums and cherries.

9. The process according to claim 8, wherein the fruit is cranberries.

10. The process according to claim 1, wherein the calcium salt of an organic acid is selected from calcium salts of lactic acid, gluconic acid, citric acid, malic acid, fumaric acid, tartaric acid, adipic acid, and mixtures thereof.

11. The process according to claim 1, wherein the calcium salt of organic acid is formed in situ in the food product by the addition to the food product of the organic acid, or a potassium, sodium or ammonium salt thereof, and calcium hydroxide, calcium hydrate or calcium carbonate.

12. The process according to claim 10, wherein the calcium salt of an organic acid is a calcium salt of lactic acid.

13. The process according to claim 1, wherein the inorganic calcium salt is selected from calcium chloride, calcium phosphate, calcium sulphate, calcium hydrate, calcium carbonate and mixtures thereof.

14. The process according to claim 1, wherein the inorganic calcium salt is formed in situ in the food product by addition to the food product of calcium hydroxide, calcium hydrate and/or calcium carbonate and phosphoric acid and/or hydrochloric acid or potassium, sodium or ammonium salt thereof.

15. The process according to claim 11, wherein the inorganic calcium salt is calcium chloride.

16. The process according to claim 1, wherein the food product after fortification with calcium has a pH lower than 4.5.

17. The process according to claim 14, wherein the food product after fortification with calcium has a pH lower than 3.5.

18. The process according to claim 1, wherein the calcium concentration in the food product after fortification is less than 3000 ppm.

19. The process according to claim 16, wherein the calcium concentration in the food product after fortification is less than 600 ppm.

20. The process according to claim 1, wherein the inorganic calcium salt is a calcium phosphate selected from mono calcium phosphate, dicalcium phosphate, tricalcium phosphate, sodium calcium phosphate, potassium calcium phosphate, ammonium calcium phosphate.

21. A calcium-enriched food product containing fruit, comprising an added inorganic calcium salt and an added calcium salt of an organic acid, wherein at least 20 wt. % of total calcium added is supplied by the organic calcium salt.

22. The calcium-enriched food product according to claim 20 wherein the organic calcium salt is calcium lactate.

23. The calcium-enriched food product according to claim 21, containing at 50 to 80 wt. % of total calcium added of calcium lactate and 10 to 50 wt. % of total calcium added of calcium chloride.

24. The calcium-enriched food product according to claim 18, which is a juice, concentrate, beverage, syrup, nectar or spread.
